(19) United States
(12) Patent Application Publication
(10) Pub. No.: US 2026/0277583 A1
(43) Pub. Date: Sep. 17, 2026

(54) FIRMWARE UPDATING METHOD AND ELECTRONIC DEVICE, ELECTRONIC SYSTEM USING THE FIRMWARE UPDATING METHOD

(71) Applicant: PixArt Imaging Inc., Hsin-Chu City (TW)

(72) Inventor: Jr-Yi Li, Hsin-Chu City (TW)

(73) Assignee: PixArt Imaging Inc., Hsin-Chu City (TW)

(21) Appl. No.: 19/082,146

(22) Filed: Mar. 17, 2025

(51) Int. Cl. G06F 8/65

(52) U.S. Cl. CPC G06F 8/65

(57) ABSTRACT

A firmware updating method, applied to a host, comprising: the host transmitting a transmitting sequence for a target device, wherein the transmitting sequence is for updating a firmware of the target device; the host initiating a monitor procedure to identify whether transmission of the transmitting sequence is finished or interrupted; the host terminating the monitor procedure if the transmission is finished; and the monitor procedure providing a notice signal to the target device or the host if the transmission is interrupted. By this way, the host or the target device can be notified of the firmware update interrupting, and the host or the target device can operate correspondingly.

### BACKGROUND OF THE INVENTION

### 1. Field of the Invention

The present invention relates to a firmware updating method and an electronic device, an electronic system using the method, and particularly relates to a firmware updating method and an electronic device, an electronic system using the method which can determine whether updating of a firmware is interrupted or not.

### 2. Description of the Prior Art

Traditionally, a host always needs to update the firmware of various devices connected thereto. However, in some cases, if the updating is interrupted, the host and the device will not be aware that the update has not been completed. In this case, the device with firmware to be updated may not work properly or may not work at all, since the firmware updating is not completed or the firmware is corrupted.

### SUMMARY OF THE INVENTION

One objective of the present invention is to provide a firmware updating method which can detect the firmware update interrupting.

Another objective of the present invention is to provide a firmware updating method which can detect the firmware update interrupting.

One embodiment of the present invention discloses a firmware updating method, applied to a host, comprising: the host transmitting a transmitting sequence for a target device, wherein the transmitting sequence is for updating a firmware of the target device; the host initiating a monitor procedure to identify whether transmission of the transmitting sequence is finished or interrupted; the host terminating the monitor procedure if the transmission is finished; and the monitor procedure providing a notice signal to the target device or the host if the transmission is interrupted.

Another embodiment of the present invention discloses an electronic device, comprising: at least one storage device, configured to store at least one program; a processing circuit, configured to control the electronic device to perform following steps: the electronic device transmitting a transmitting sequence for a target device, wherein the transmitting sequence is for updating a firmware of the target device; the electronic device initiating a monitor procedure to identify whether transmission of the transmitting sequence is finished or interrupted; the electronic device terminating the monitor procedure if the transmission is finished; and the monitor procedure providing a notice signal to the target device or the electronic device if the transmission is interrupted.

In one embodiment, the target device comprises a first storage device and a second storage device. The controller further controls the target device to perform following steps: the target device executing at least one program in the first storage device to operate in a first mode; and the target device executing at least one program in the second storage device to operate in a second mode; wherein the electronic device updates the firmware in the first storage device in the second mode

In view of above-mentioned embodiments, the host or the target device can be notified of the firmware update interrupting, and the host or the target device can operate correspondingly. Thus, the issue of the conventional firmware updating method can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a firmware updating method according to one embodiment of the present invention.

FIG. 2 is a schematic diagram illustrating a progress bar of updating the firmware, according to one embodiment of the present invention.

FIG. 3 is a block diagram illustrating detail operations of updating the firmware, according to one embodiment of the present invention.

FIG. 4 is a block diagram illustrating detail structures of the first storage device in FIG. 3, according to one embodiment of the present invention.

FIG. 5 is a flow chart illustrating a firmware updating method, according to one embodiment of the present invention.

### DETAILED DESCRIPTION

In the following descriptions, the term “first”, “second”, “third” are only for the purpose of distinguishing different one elements, and do not mean the sequence of the elements. For example, a first device and a second device only mean these devices can have the same structure but are different devices.

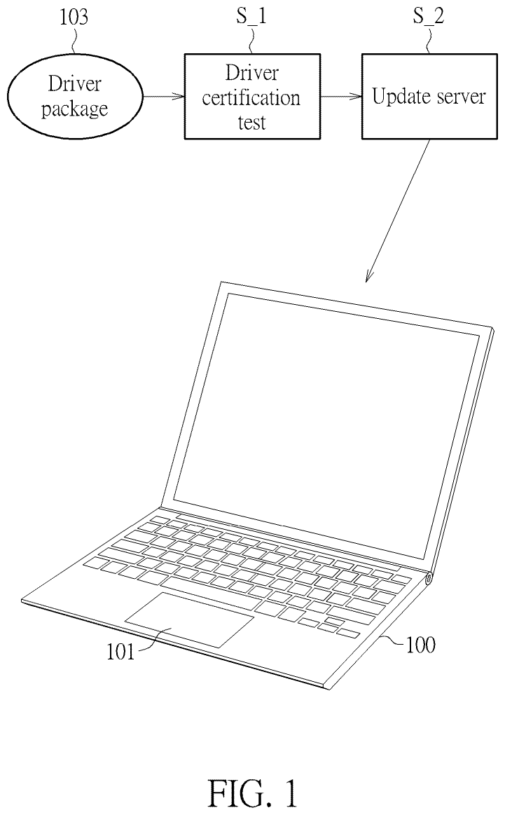

FIG. 1 is a schematic diagram illustrating a firmware updating method according to one embodiment of the present invention. In following embodiments, an electronic system comprising a laptop 100 and a touch pad 101 thereof are used as examples for explaining. However, the laptop 100 can be replaced by any other electronic device which serves as a host, and the touch pad 101 can be replaced by any other target device. Also, the target device is not limited to be provided inside the host.

In the embodiment of FIG. 1, a driver package 103 may be provided by a firmware source. For example, the driver package 103 may be provided by a manufacturer of the laptop 100 or a manufacturer of the touch pad 101. The driver package 103 may comprise the updating data of a firmware of the touch pad 101, or comprising a newest version of firmware. The driver package 103 may further comprise other software components, corresponding to the OS (operation system) which the laptop 100 uses. For example, the driver package 103 may comprise an on line updating application, a monitor application, a service file (ex. Windows service), a firmware binary file or an Inf file. The monitoring application can be used for the monitoring procedure described below.

Next, the driver package 103 is tested by a driver certification test S_1. The driver certification test S_1 may be provided by the OS manufacturer to ensure that the driver (firmware) of the touch pad 101 can run smoothly in the OS. For example, if the OS is Windows, the driver certification test S_1 may be HLK (Hardware Lab Kit) test. After the driver package 103 passes the driver certification test S_1, the laptop 101 can download the driver package 103 via the update server S_2. The update server S_2 may have different names and contents corresponding to the OS which the laptop 100 uses. For example, if the OS is Windows, the update server S_2 is a windows update server.

After downloading the driver package 103, the laptop 100 may start to update the firmware. The operation of “update the firmware” may mean installing the updating data to the firmware, or installing the newest version of the firmware. During updating the firmware, the laptop 101 may initiate a monitor procedure to monitor whether the operation of “update the firmware” is completed or not (i.e., succeed or failed). In one embodiment, the laptop 101 transmits a transmitting sequence for the touch pad 101, wherein the transmitting sequence is for updating the firmware of the touch pad 101. The transmitting sequence may mean a data sequence such as a bit sequence. Thus, the transmitting sequence may comprise data of the above-mentioned updating data, or data of the newest version of the firmware.

In such case, the laptop 100 initiates the above-mentioned monitor procedure to identify whether transmission of the transmitting sequence is finished or interrupted. The transmission of the transmitting sequence may mean, for example, the transmission to a storage device which stores the firmware of the touch pad 101. Details of the storage device will be described in following descriptions. The monitor procedure can be implemented by various software. For example, in one embodiment, the OS is Windows and the monitor procedure is a WMI (Windows Management Instrumentation). If the transmission is finished, which may represent the operation of “updating the firmware” is completed, the laptop 100 terminates the monitor procedure. On the opposite, if the transmission is interrupted, the monitor procedure provides a notice signal to the touch pad 101. In another embodiment, if the transmission is interrupted, the laptop 100 or the touch pad 101 may operate correspondingly. For example, if the transmission is interrupted, the laptop 100 or the touch pad 101 may reboot, or the process of updating the firmware may restart again.

Details of the operation of “update the firmware” will be described in following descriptions. In one embodiment, the firmware of the touch pad 101 is updated by a service of the OS. For example, if the OS is Windows, the laptop 100 launches the Windows service, which can comprise an updater or the above-mentioned monitor procedure, to update the firmware of the touch pad 101. After the transmission of the transmitting sequence is finished, the service may be stopped to release the source of computing.

As above-mentioned, the laptop 100 initiates the monitor procedure to identify whether transmission of the transmitting sequence is finished or interrupted. In one embodiment, the transmission maybe interrupted by at least one of following operations: the laptop 101 is rebooted during updating the firmware, the laptop 101 is shut down during updating the firmware, the laptop 101 enters a sleep mode during updating the firmware, a cover of the laptop 100 is closed during updating the firmware, or an account of the laptop 100 is logged out during updating the firmware.

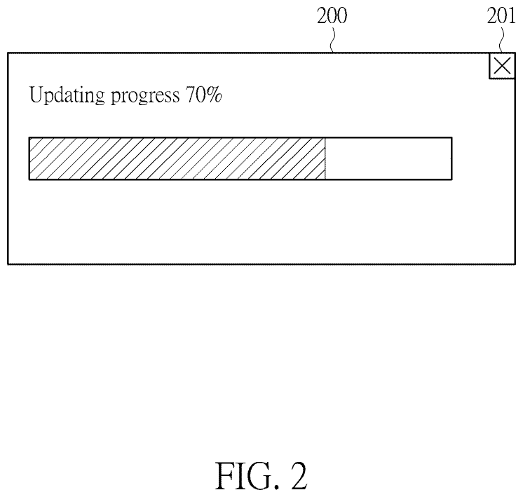

In one embodiment, the transmission of the transmitting sequence is interrupted if the updating is forced to be interrupted. FIG. 2 is a schematic diagram illustrating a progress bar of updating the firmware, according to one embodiment of the present invention. In the embodiment of FIG. 2, a progress bar 200 which represents a progress of updating the firmware is displayed on a display of the laptop 100. The transmission of the transmitting sequence may be interrupted by deactivating the progressing bar 200, for example, a user clicks the X symbol 201 of the progressing bar 200.

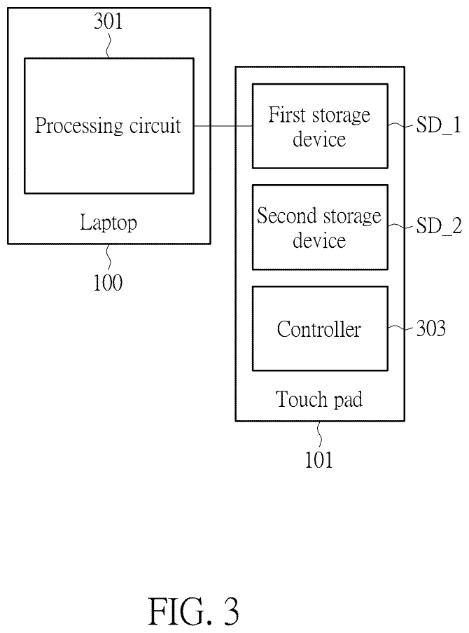

As above-mentioned, the transmission of the transmitting sequence may mean the transmission to a storage device which stores the firmware of the touch pad 101. FIG. 3 is a block diagram illustrating detail operations of updating the firmware, according to one embodiment of the present invention. As shown in FIG. 3, the laptop 100 further comprises a processing circuit 301, which is configured to control the operations of the laptop 100, for example, the processing circuit 301 controls the firmware updating. Also, the touch pad 101 comprises a controller 303, a first storage device SD_1 and a second storage device SD_2. The controller 303 (e.g., a MCU or a control circuit) is configured to control the operations of the touch pad 101. Please note, the first storage device SD_1 and a second storage device SD_2 may also be provided in the laptop 100. In one embodiment, the first storage device SD_1 is a flash memory and the second storage device is a ROM (Read Only Memory) SD_2. Also, the function of the controller 303 may be incorporated into the processing circuit 301.

The controller 303 executes at least one program in the first storage device SD_1 to operate in a first mode. In one embodiment, the laptop 100 receives data of the above-mentioned transmitting sequence in the first mode. Accordingly, the first mode may mean a normal mode in which the laptop 100 does not update the firmware of the touch pad 101 yet and the touch pad 101 operate normally. Also, the controller 303 executes at least one program in the second storage device SD_2 to operate in a second mode. In one embodiment, the laptop 100 updates the firmware in the first storage device SD_1 in the second mode. In other words, the controller 303 does not execute the programs in the first storage device SD_1 while updating the firmware in the first storage device SD_1. Accordingly, in the embodiment of FIG. 3, the above-mentioned transmitting sequence is transmitted to the first storage device SD_1.

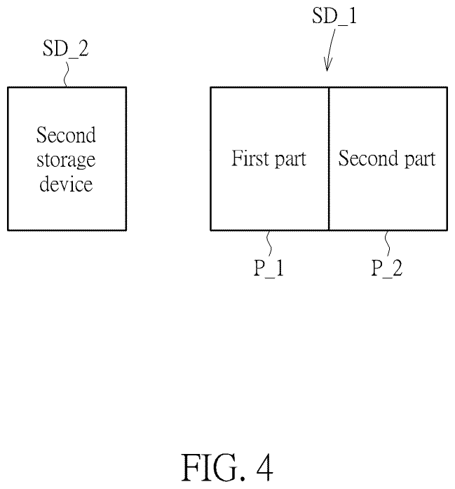

FIG. 4 is a block diagram illustrating the detail structures of the first storage device and the second storage device in FIG. 3, according to one embodiment of the present invention. In the embodiment of FIG. 4, the first storage device SD_1 has a first part P_1 and a second part P_2. The first part P_1 and the second part P_2 may mean the regions with different addresses of the first storage device SD_1. For example, if the first storage device SD_1 is a memory, the first part P_1 and the second part P_2 may mean the regions with different memory addresses.

In the embodiment of FIG. 4, the controller 303 executes at least one program in the first part P_1 of the first storage device SD_1 to operate in the above-mentioned first mode. On the contrary, the controller 303 executes at least one program in the second part P_2 of the first storage device SD_1 to operate in a third mode. In one embodiment, the touch pad 101 reboots in the third mode. In such case, the data stored in the second part P_2 maybe a backup of the data stored in the first part P_1. For example, during updating the firmware in the first part P_1, if the above-mentioned monitor procedure finds that the updating is interrupted, the touch pad 101 may be informed and reboot according to the program in the second part P_2, since the program stored in the first part P_1 may already corrupt.

For more detail, in the embodiment of FIG. 4, while updating the firmware, the controller 303 executes the programs in the second storage device SD_2 to control the touch pad 101. In a conventional firmware updating method, if the updating is interrupted, the controller 103 may not be aware of the interrupting and may still go back to use the program in the first part P_1 to control the touch pad 101. In such case, the touch pad 101 may not operate normally, since the updating of the firmware thereof is not completed. In the present invention, the touch pad 101 may be informed by the monitor procedure that the updating is interrupted, and can operate correspondingly. For example, the touch pad 101 may automatically reboot to recover the program in the first part P_1, or switches to use the program in the second part P_2 to operate, or switches to use the program in the second storage device SD_2 to operate. Also, the laptop 100 may also be informed and re-starts the firmware updating accordingly.

As above-mentioned, the first storage device SD_1 and the second storage device SD_2 may be provided in the laptop 100. In such case, the operations of the touch pad 101 illustrated in FIG. 3 and FIG. 4 may be performed by the laptop 100.

Besides the transmission of the transmitting sequence, other methods can also be used to monitor whether the operation of “updating the firmware” is completed. In one embodiment, the data to be updated (the original data) can be compared to the corresponding data which has been written (the written data) to a storage device storing the firmware (e.g., the above-mentioned first storage device SD_1). If the original data and the written data are the same, it means the operation of “updating the firmware” is completed (succeed). On the contrary, if the original data and the written are different, it means the operation of “updating the firmware” is interrupted (fails). Please note, the original data and the written data mentioned here can mean all of the data to be updated to the firmware, or only a portion of the data to be updated to the firmware.

Also, in another embodiment, the laptop 100 can request the touch pad 101 to provide a version of the firmware. If the version is correct, it means the operation of “updating the firmware” is completed. On the contrary, if the version is incorrect, it means the operation of “updating the firmware” is interrupted. In still another embodiment, the laptop 101 can monitor if the touch pad 101 switches back to use the first storage device SD_1 to operate, since the touch pad 101 uses the second storage device SD_2 to operate while the firmware is being updated.

In still another embodiment, the laptop 100 can acquire the CRC of the data to be updated to determine whether the operation of “updating the firmware” is completed. In still another embodiment, the laptop 100 can determine whether the operation of “updating the firmware” is completed according to a report descriptor, which represents if any function of the touch pad 101 is updated due to the updating of the firmware. In still another embodiment, the laptop 100 can periodically asks the touch pad 101 that if the touch pad 101 operate normally.

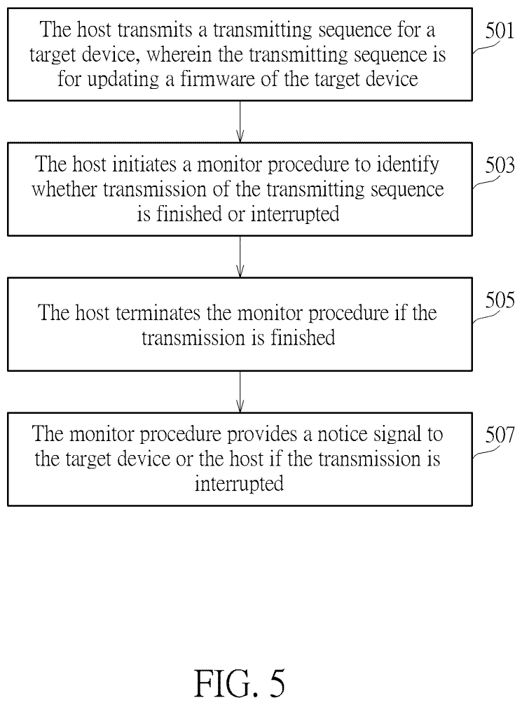

In view of above-mentioned embodiments, a firmware updating method can be acquired. FIG. 5 is a flow chart illustrating a firmware updating method, according to one embodiment of the present invention, which comprises following steps:

### Step 501

The host (e.g., the laptop 100 in FIG. 1) transmits a transmitting sequence for a target device (e.g., the touch pad 101 in FIG. 1), wherein the transmitting sequence is for updating a firmware of the target device.

In one embodiment, the transmitting sequence is transmitted to a storage device comprising the firmware to be updates, such as the first storage device SD_1 in FIG. 3.

### Step 503

The host initiates a monitor procedure to identify whether transmission of the transmitting sequence is finished or interrupted.

### Step 505

The host terminates the monitor procedure if the transmission is finished.

### Step 507

The monitor procedure provides a notice signal to the target device or the host if the transmission is interrupted.

If the host receives the notice signal, it can re-start the firmware updating or using another procedure to inform the touch pad 101.

In view of above-mentioned embodiments, the host or the target device can be notified of the firmware update interrupting, and the host or the target device can operate correspondingly. Thus, the issue of the conventional firmware updating method can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A firmware updating method, applied to a host, comprising:
the host transmitting a transmitting sequence for a target device, wherein the transmitting sequence is for updating a firmware of the target device;
the host initiating a monitor procedure to identify whether transmission of the transmitting sequence is finished or interrupted;
the host terminating the monitor procedure if the transmission is finished; and
the monitor procedure providing a notice signal to the target device or the host if the transmission is interrupted.

2. The firmware updating method of claim 1, wherein the host receives data of the transmitting sequence in a form of a driver packet, wherein the firmware of the target device is updated by a service provided by an OS (operating system ) of the host.

3. The firmware updating method of claim 2, wherein the OS stops the service when the transmission of the transmitting sequence is finished.

4. The firmware updating method of claim 1, wherein the transmission is interrupted by at least one of following operations:
the host being rebooted, the host being shut down, the host entering a sleep mode, a cover of the host being closed, an account of the host being logged out, the updating is forced to be interrupted.

5. The firmware updating method of claim 1, further comprising:
displaying a progress bar representing a progress of updating the firmware;
wherein the transmission is interrupted by deactivating the progressing bar.

6. The firmware updating method of claim 1,
wherein the host comprises a first storage device and a second storage device;
wherein the firmware updating method further comprises:
the target device executing at least one program in the first storage device to operate in a first mode; and
the target device executing at least one program in the second storage device to operate in a second mode;
wherein the host updates the firmware in the first storage device in the second mode.

7. The firmware updating method of claim 6,
wherein the host receives data of the transmitting sequence in the first mode.

8. The firmware updating method of claim 6,
wherein the first storage comprises a first part and a second part;
wherein the firmware updating method further comprises:
the target device executing at least one program in the first part of the first storage device to operate in the first mode;
the target device executing at least one program in the second part of the first storage device to operate in a third mode.

9. The firmware updating method of claim 8, wherein the target device reboots in the third mode.

10. The firmware updating method of claim 6, wherein the first storage device is a flash memory and the second storage device is a ROM (Read Only Memory).

11. An electronic device, comprising:
at least one storage device, configured to store at least one program;
a processing circuit, configured to control the electronic device to perform following steps:
the electronic device transmitting a transmitting sequence for a target device, wherein the transmitting sequence is for updating a firmware of the target device;
the electronic device initiating a monitor procedure to identify whether transmission of the transmitting sequence is finished or interrupted;
the electronic device terminating the monitor procedure if the transmission is finished; and
the monitor procedure providing a notice signal to the target device or the electronic device if the transmission is interrupted.

12. The electronic device of claim 11, wherein the electronic device receives data of the transmitting sequence in a form of a driver packet, wherein the firmware of the target device is updated by a service provided by an OS (operating system ) of the electronic device.

13. The electronic device of claim 12, wherein the OS stops the service when the transmission of the transmitting sequence is finished.

14. The electronic device of claim 11, wherein the transmission is interrupted by at least one of following operations:
the electronic device being rebooted, the electronic device being shut down, the electronic device entering a sleep mode, a cover of the electronic device being closed, an account of the electronic device being logged out, the updating is forced to be interrupted.

15. The electronic device of claim 11, further comprising:
displaying a progress bar representing a progress of updating the firmware;
wherein the transmission is interrupted by deactivating the progressing bar.

16. An electronic system, comprising:
a target device, comprising a controller;
an electronic device, comprising:
at least one storage device, configured to store at least one program;
a processing circuit, configured to control the electronic device to perform following steps:
the electronic device transmitting a transmitting sequence for the target device, wherein the transmitting sequence is for updating a firmware of the target device;
the electronic device initiating a monitor procedure to identify whether transmission of the transmitting sequence is finished or interrupted;
the electronic device terminating the monitor procedure if the transmission is finished; and
the monitor procedure providing a notice signal to the target device or the electronic device if the transmission is interrupted;
wherein the target device comprises a first storage device and a second storage device;
wherein the controller further controls the target device to perform following steps:
the target device executing at least one program in the first storage device to operate in a first mode; and
the target device executing at least one program in the second storage device to operate in a second mode;
wherein the electronic device updates the firmware in the first storage device in the second mode.

17. The electronic system of claim 16,
wherein the electronic device receives data of the transmitting sequence in the first mode.

18. The electronic system of claim 16,
wherein the first storage comprises a first part and a second part;
wherein the target device executes at least one program in the first part of the first storage device to operate in the first mode;
wherein the target device executes at least one program in the second part of the first storage device to operate in a third mode.

19. The electronic system of claim 18, wherein the target device reboots in the third mode.

20. The electronic system of claim 16, wherein the first storage device is a flash memory and the second storage device is a ROM (Read Only Memory).
